(19) United States
(12) Patent Application Publication
(10) Pub. No.: US 2011/0157726 A1
(43) Pub. Date: Jun. 30, 2011

(54) LENS WITH MULTIPLE PROTRUSIONS

(75) Inventors: YU-SHU CHEN, Chu-Nan (TW); AN-CHI WEI, Chu-Nan (TW); CHIH-CHUNG TSAO, Chu-Nan (TW); SHAN-JU LIN, Chu-Nan (TW)

(73) Assignee: FOXSEMICON INTEGRATED TECHNOLOGY, INC., Chu-Nan (TW)

(21) Appl. No.: 12/835,742

(22) Filed: Jul. 14, 2010

(30) Foreign Application Priority Data
Dec. 28, 2009 (CN) 200910312373.1

(51) Int. Cl. G02B 3/08

(52) U.S. Cl. 359/742

(57) ABSTRACT

A non-imaging lens includes a transparent member, a first Fresnel lens portion and a second Fresnel lens portion. The transparent member includes a first surface and a second surface. The first Fresnel lens portion includes a plurality of first saw-toothed protrusions concentrically defined on the first surface. The second Fresnel lens portion includes a plurality of second saw-toothed protrusions concentrically defined on the first surface. The second saw-toothed protrusions are defined around the first saw-toothed protrusions. Each of radii of curvature of the second saw-toothed protrusions is different from each of radii of curvature of the first saw-toothed protrusions.

### CROSS-REFERENCE TO RELATED APPLICATIONS

This application is related to patent application Ser. No. ______, entitled as “LENS WITH A DETERMINED PITCH” and filed on ______, 2010 (Attorney Docket No. US 26737) and patent application Ser. No. ______, entitled as “LENS WITH INCREASING PITCHES” and filed on ______, 2010 (Attorney Docket No. US 26738). Such applications have the same inventors and assignee as the present application.

### BACKGROUND

1. Technical Field

The disclosure relates generally to lenses, and more particularly to a lens for condensing solar light.

2. Description of the Related Art

Generally, solar light is considered to be aligned. A standard Fresnel lens is configured for concentrating solar light for a solar cell plate. However, the intensity of light through the Fresnel lens is not uniform. Moreover, when the size of the solar cell plate is decreased to 4 mm*4 mm, the intensity of the center is higher than that at the periphery. Thus, what is called for is a lens that can overcome the limitations described.

### BRIEF DESCRIPTION OF THE DRAWINGS

FIG. 1 is a cross section of a lens in accordance with one embodiment of the disclosure.

FIG. 2 is an illumination distribution map of the lens of FIG. 1.

### DETAILED DESCRIPTION

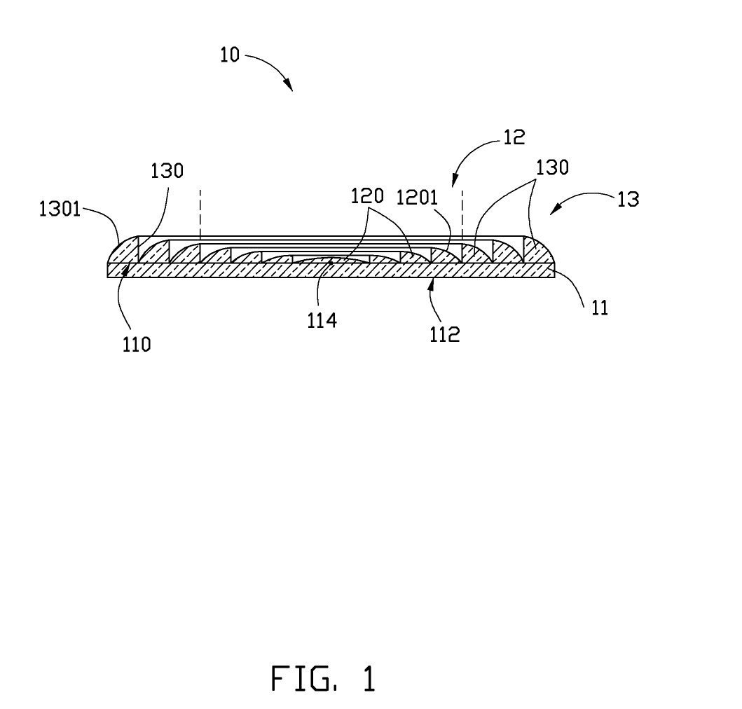

Referring to FIG. 1, a non-imaging lens 10 in accordance with one embodiment of the disclosure includes a transparent member 11, a first Fresnel lens portion 12 and a second Fresnel lens portion 13.

The transparent member 11 is circular. The transparent member 11 includes a first surface 110 and a second surface 112. The first surface 110 and the second surface 112 are planar. The second surface 112 is configured for receiving solar light. The transparent member 11 is made of resin or glass.

The first Fresnel lens portion 12 is defined on the first surface 110. The first Fresnel lens portion 12 includes a plurality of first saw-toothed protrusions 120. The first saw-toothed protrusions 120 are annular and concentrically defined around a center 114 of the transparent member 11.

The second Fresnel lens portion 13 is defined on the first surface 110. The second Fresnel lens portion 13 includes a plurality of second saw-toothed protrusions 130. The second saw-toothed protrusions 130 are annular and concentrically defined around the first saw-toothed protrusions 120. Each of cross sections of the first saw-toothed protrusions 120 and each of cross sections of the second saw-toothed protrusions 130 form a part of a circle.

Each of radii of curvature of curved surfaces 1201 of the first saw-toothed protrusions 120 exceeds each of radii of curvature of curved surfaces 1301 of the second saw-toothed protrusions 130. The first saw-toothed protrusions 120 are configured for adjusting the intensity of light through the center 114 of the transparent member 11.

The first saw-toothed protrusions 120 and the second saw-toothed protrusions 130 can be defined around different centers.

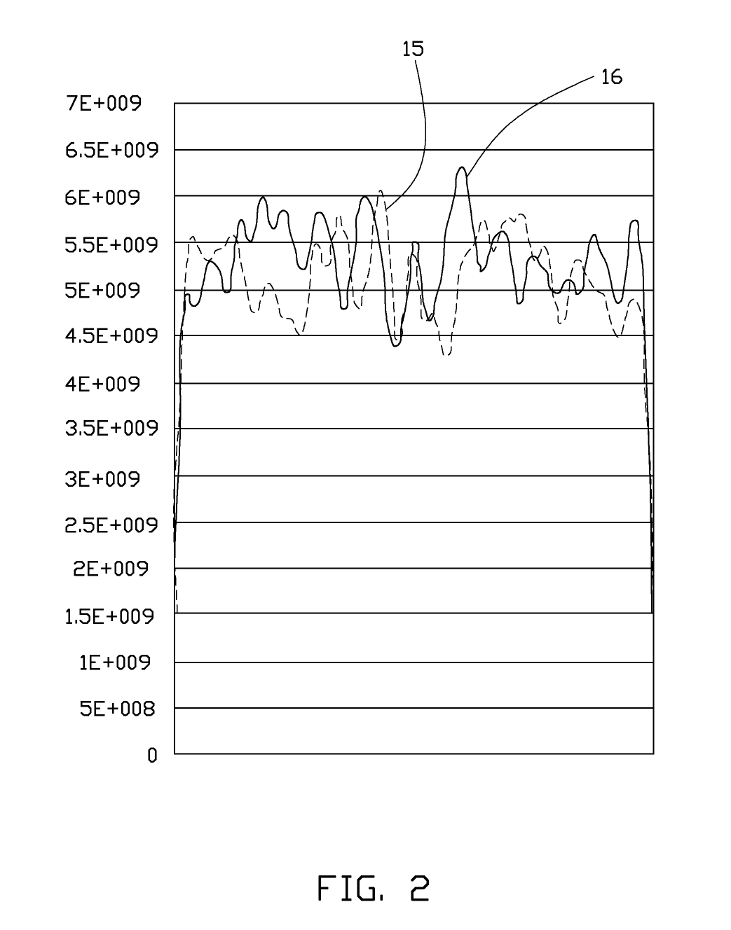

FIG. 2 is an illumination distribution map of the lens 10 under conditions as follows. First, the solar cell plate (not shown) is 4 mm*4 mm. Second, the radius of the lens 10 is 300 mm. Third, the distance between the solar cell plate (not shown) and the lens 10 is 300 mm.

The curve 15 shows the intensity of solar light through the lens 10 along an X-axis. The curve 16 shows the intensity of solar light through the lens 10 along a Y-axis. As shown in the curve 15 and the curve 16, the intensity of the solar light through the lens 10 is uniform.

The focal distances of the first Fresnel lens portion 12 and the second Fresnel lens portion 13 can be uniform or different. The widths of the first saw-toothed protrusions 120 and widths of the second saw-toothed protrusions 130 can be determined according to specific requests. The widths of the first saw-toothed protrusions 120 and widths of the second saw-toothed protrusion 130 are uniform. Alternatively, the widths of the first saw-toothed protrusions 120 and widths of the second saw-toothed protrusions 130 are different.

Uniform intensity can be easily obtained by utilizing the non-imaging lens 10 with first Fresnel lens portion 12 and the second Fresnel lens portion 13.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A non-imaging lens comprising:
a transparent member comprising a first surface and a second surface opposite to the first surface;
a first Fresnel lens portion comprising a plurality of first saw-toothed protrusions concentrically defined on the first surface of the transparent member; and
a second Fresnel lens portion comprising a plurality of second saw-toothed protrusions concentrically defined on the first surface of the transparent member, the second saw-toothed protrusions defined around the first saw-toothed protrusions, a cross section of each of the first saw-toothed protrusions and a cross section of each of the second saw-toothed protrusions each forming a part of a circle, wherein each of radii of curvature of curved surfaces of the second saw-toothed protrusions differs from each of radii of curvature of curved surfaces of the first saw-toothed protrusions, the second surface of the transparent member configured for receiving solar light.

2. The lens as claimed in claim 1, wherein the first saw-toothed protrusions and the second saw-toothed protrusions are concentrically defined around a common center.

3. The lens as claimed in claim 1, wherein the first saw-toothed protrusions and the second saw-toothed protrusions are concentrically defined around different centers.

4. The lens as claimed in claim 2, wherein each of radii of curvature of the first saw-toothed protrusions exceeds each of radii of curvature of the second saw-toothed protrusions.

5. The lens as claimed in claim 1, wherein a focal length of the first Fresnel lens portion and a focal length of the second Fresnel lens portion are uniform.

6. The lens as claimed in claim 1, wherein a focal length of the first Fresnel lens portion and a focal length of the second Fresnel lens portion are different.

7. The lens as claimed in claim 1, wherein widths of the first saw-toothed protrusions and widths of the second saw-toothed protrusion are uniform.

8. The lens as claimed in claim 1, wherein widths of the first saw-toothed protrusions and widths of the second saw-toothed protrusion are different.

9. A non-imaging lens comprising:
a transparent member comprising a first surface and a second surface opposite to the first surface;
a first Fresnel lens portion comprising a plurality of first saw-toothed protrusions concentrically defined on the first surface of the transparent member; and
a second Fresnel lens portion comprising a plurality of second saw-toothed protrusions concentrically defined on the first surface of the transparent member, the second saw-toothed protrusions defined around the first saw-toothed protrusions, a cross section of each of the first saw-toothed protrusions and a cross section of each of the second saw-toothed protrusions each forming a part of a circle, wherein each of radii of curvature of curved surfaces of the second saw-toothed protrusions exceeds each of radii of curvature of curved surfaces of the first saw-toothed protrusions, the second surface of the transparent member configured for receiving solar light.

10. The lens as claimed in claim 9, wherein the first saw-toothed protrusions and the second saw-toothed protrusions are concentrically defined around a common center.

11. The lens as claimed in claim 9, wherein the first saw-toothed protrusions and the second saw-toothed protrusions are concentrically defined around different centers.

12. The lens as claimed in claim 9, wherein a focal length of the first Fresnel lens portion and a focal length of the second Fresnel lens portion are uniform.

13. The lens as claimed in claim 9, wherein a focal length of the first Fresnel lens portion and a focal length of the second Fresnel lens portion are different.

14. The lens as claimed in claim 9, wherein widths of the first saw-toothed protrusions and widths of the second saw-toothed protrusion are uniform.

15. The lens as claimed in claim 9, wherein widths of the first saw-toothed protrusions and widths of the second saw-toothed protrusion are different.
